(19) United States
(12) Patent Application Publication
(10) Pub. No.: US 2018/0056680 A1
(43) Pub. Date: Mar. 1, 2018

(54) SHEET STORAGE DEVICE AND IMAGE FORMING APPARATUS

(71) Applicant: KYOCERA Document Solutions Inc., Osaka-shi (JP)

(72) Inventors: Hironori Daigo, Osaka-shi (JP); Takuya Nishimura, Osaka-shi (JP)

(21) Appl. No.: 15/684,131

(22) Filed: Aug. 23, 2017

(30) Foreign Application Priority Data
Aug. 29, 2016 (JP) 2016-166776

(51) Int. Cl. B41J 13/00; G03G 15/00

(52) U.S. Cl. CPC B41J 13/0036; G03G 15/6502; B65H 2405/31; B65H 2405/11; B65H 2701/1131; B65H 2511/10; B65H 2405/32

(57) ABSTRACT

A sheet storage device has a rotation restriction portion configured to restrict a rotation of an end cursor from a first posture to a second posture. The rotation restriction portion has: a restriction piece situated on the end cursor and configured to be brought into contact with a guide rail so as to restrict the rotation of the end cursor from the first posture to the second posture; and an engagement recess formed at a given position of the guide rail, the restriction piece being fitted in the engagement recess. The end cursor is allowed to rotate from the first posture to the second posture when the restriction piece is fitted in the engagement recess at the given position of the guide rail.

### INCORPORATION BY REFERENCE

This application is based on Japanese Patent Application Serial No. 2016-166776 filed in Japan Patent Office on Aug. 29, 2016, the contents of which are hereby incorporated by reference.

### BACKGROUND

The present disclosure relates to a sheet storage device and an image forming apparatus, each of which includes a detector configured to detect a size of sheets, the sheets being stored in a sheet feeding cassette.

A known sheet storage device includes a detector configured to detect a size of sheets which are stored in a sheet feeding cassette. This sheet storage device is used in an image forming apparatus such as a copier or a printer.

The sheet storage device has an end cursor inside the sheet feeding cassette, the end cursor being used for restricting a position of trailing edges of the sheets in a sheet feeding direction. The end cursor is slidable in the sheet feeding direction. When an operator slides and brings the end cursor into contact with the trailing edges of the sheets in the sheet feeding direction, the size of the sheets is detected by the detector.

### SUMMARY

A sheet storage device according to one aspect of the present disclosure includes a sheet feeding cassette configured to store a sheet; an end cursor supported so as to rotate between a first posture, at which the end cursor protrudes upwardly from a bottom plate of the sheet feeding cassette, and a second posture, at which the end cursor is situated in parallel to the bottom plate, the end cursor in the first posture being brought into contact with trailing edge of the sheet in a sheet feeding direction; a guide rail extending on the bottom plate along the sheet feeding direction to guide a sliding movement of the end cursor; a detector configured to detect the size of the sheet based on a position of the end cursor in the sheet feeding direction; and a rotation restriction portion restricting a rotation of the end cursor from the first posture to the second posture, and including a restriction piece situated on the end cursor so as to be brought into contact with the guide rail and restrict the rotation of the end cursor from the first posture to the second posture; and an engagement recess formed at a given position of the guide rail so that the restriction piece is fitted in the engagement recess. The end cursor is allowed to rotate from the first posture to the second posture when the restriction piece is fitted in the engagement recess at the given position of the guide rail.

### BRIEF DESCRIPTION OF THE DRAWINGS

FIG. 1 is a perspective view showing an exemplificative sheet storage device.

FIG. 2 is another perspective view showing the sheet storage device depicted in FIG. 1.

FIG. 3 is a perspective view showing an end cursor of the sheet storage device depicted in FIG. 1.

FIG. 4 is a perspective view showing a folded state of the end cursor depicted in FIG. 3.

FIG. 5 is a side view showing the end cursor depicted in FIG. 3.

FIG. 6 is a perspective view showing the end cursor located at a position distant from a given position.

### DESCRIPTION OF EMBODIMENTS

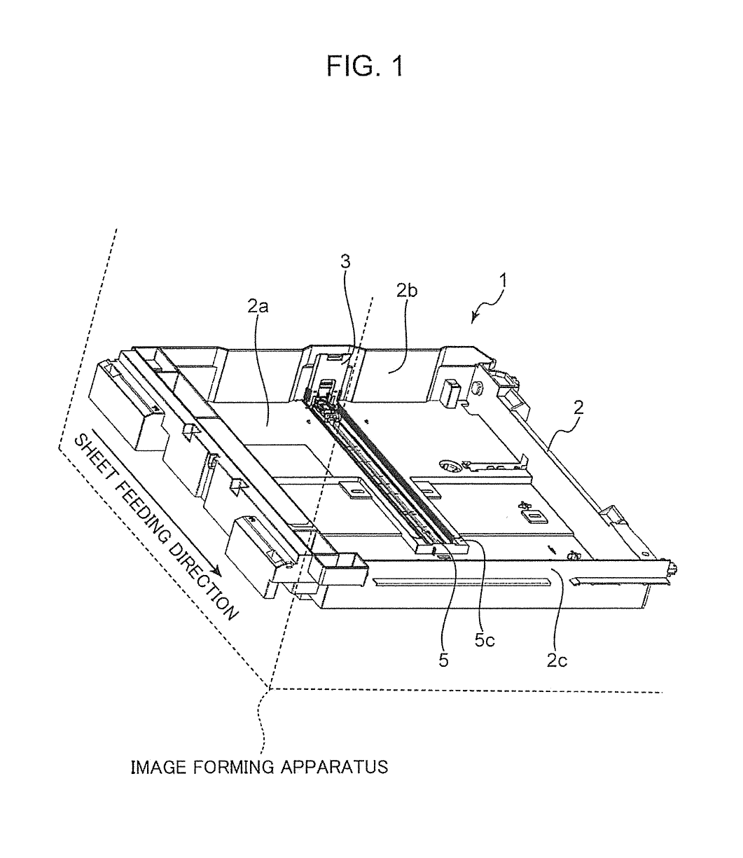

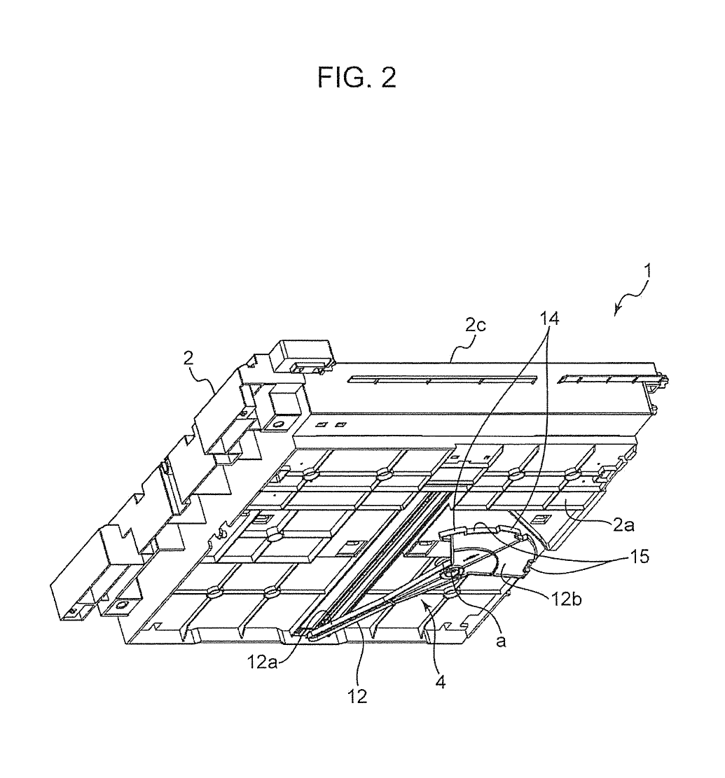

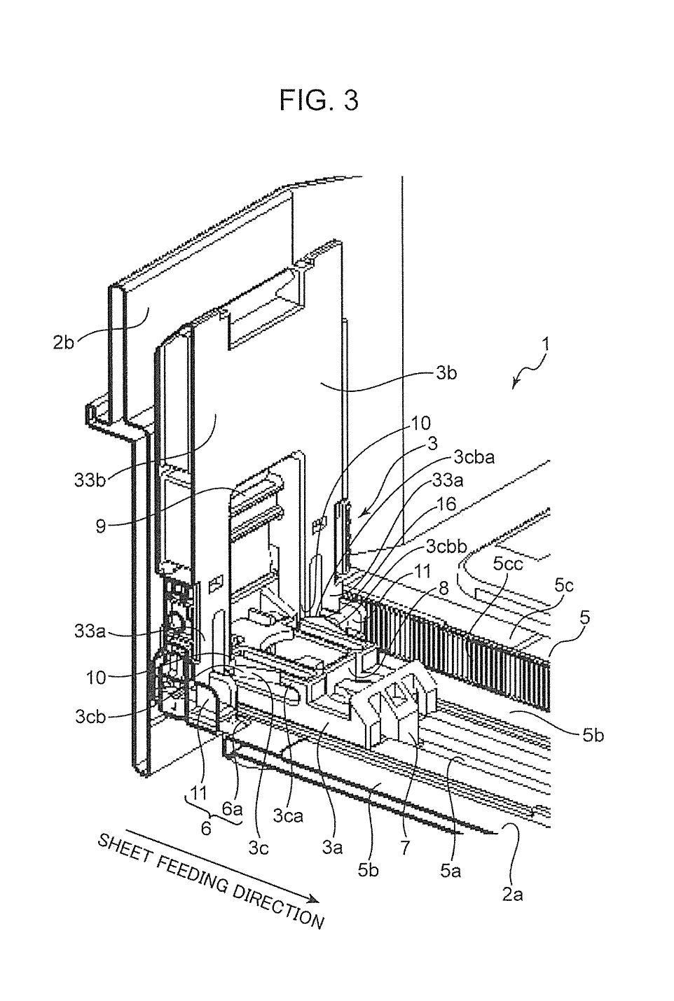

FIG. 1 is a perspective view showing an exemplificative sheet storage device 1. FIG. 2 is another perspective view showing the sheet storage device 1. FIG. 3 is a perspective view showing an end cursor 3 of the sheet storage device 1. As shown in FIG. 1, the sheet storage device 1 is stored in an image forming apparatus. The sheet storage device 1 includes: a sheet feeding cassette 2 configured to store sheets which are different in size; an end cursor 3 configured to restrict a position of the sheets in a sheet feeding direction; a detector 4 configured to detect the size of the sheets on the basis of a position of the end cursor 3 in the sheet feeding direction; and a rotation restriction portion 6 configured to restrict a rotation of the end cursor 3.

The sheet feeding cassette 2 is shaped in a box which is opened upwardly. The sheet feeding cassette 2 includes: a bottom plate 2a on which the sheets are placed, an upstream wall 2b which stands upwardly from an upstream end of the bottom plate 2a in the sheet feeding direction; and a downstream wall 2c which stands upwardly from a downstream end of the bottom plate 2a in the sheet feeding direction.

The bottom plate 2a of the sheet feeding cassette 2 has a rail portion 5 designed as a runway for the end cursor 3. The rail portion 5 includes: a rail groove 5a extending in the sheet feeding direction; two guide rails 5b, 5b, which are situated on both sides of the rail groove 5a and extend in the sheet feeding direction along the rail groove 5a to face a part of the end cursor 3; and a sidewall 5c which is shaped in a rectangular frame and protrudes upwardly from the bottom plate 2a. The rail groove 5a opened through the bottom plate 2a extends from a position adjacent to the upstream wall 2b to a vicinity of the downstream wall 2c. The two guide rails 5b, 5b are situated at an interval to be in parallel to the rail groove 5a. Each of the two guide rails 5b, 5b extends from a position adjacent to the upstream wall 2b to a vicinity of the downstream wall 2c. The sidewall 5c is situated on the bottom plate 2a so as to surround the rail groove 5a and the guide rails 5b, 5b. A rack 5cc having a lot of grooves configured to engage with an engagement pawl which is described below is formed on a surface of the sidewall 5c which extends in the sheet feeding direction and stand upright.

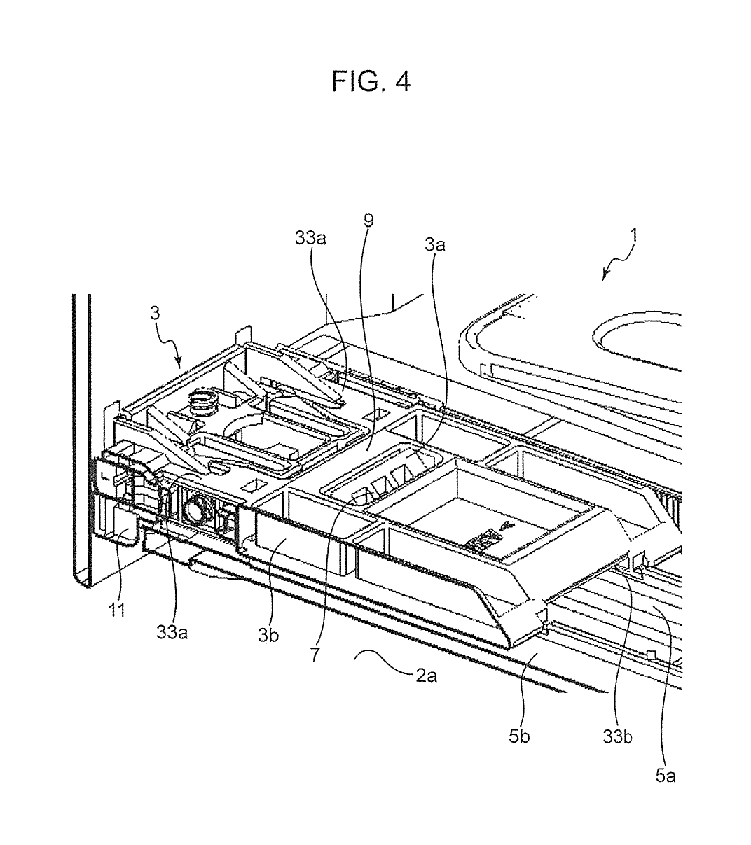

FIG. 4 is a perspective view showing the end cursor 3 in a folded state. The end cursor 3 is described with reference to FIGS. 3 and 4. The end cursor 3 is slidable in the sheet feeding direction. The end cursor 3 includes a base plate 3a which is shaped substantially in a flat plate and configured to slide along the rail groove 5a; a cursor 3b which is brought in contact with trailing edges of the sheets in the sheet feeding direction; and a lock portion 3c (c.f. FIG. 3) for locking the cursor 3b. The base plate 3a is substantially rectangular. A downwardly convex engagement portion 7 is formed at a leading end of the base plate 3a in the sheet feeding direction, the engagement portion 7 being fitted in the rail groove 5a. Accordingly, the base plate 3a may be moved along the rail groove 5a. A fitting recess 8 is formed on an upper surface of the base plate 3a, a latch portion described below being fitted in the fitting recess 8.

The cursor 3b is formed in an inverse U shape. The cursor 3b has two leg portions 33a, 33a, which extend downwardly, and a base end portion 33b connecting the two leg portions 33a, 33a together. The cursor 3b is rotatable and attached to an upstream end of the base plate 3a so that the two leg portions 33a, 33a sandwiches both sides of the base plate 5a. Accordingly, the cursor 3b may be rotated between a first posture, at which the cursor 3b protrudes upwardly from the bottom plate 2a, and a second posture, at which the cursor 3b is situated in parallel to the bottom plate 2a. The cursor 3b in the first posture is brought into contact with the trailing edges of the sheets in the sheet feeding direction. The term “first posture” means not only an upright posture, in which the cursor 3b stands at a right angle with respect to the bottom plate 2a, but also a posture in which the cursor 3b is rotated slightly from the upright posture. The term “second posture” means not only a horizontal posture, in which the cursor 3b is in parallel to the bottom plate 2a, but also a posture, in which the cursor 3b is rotated slightly from the horizontal posture. The cursor 3b has a latch portion 9, which is situated underneath the base end portion 33b, the latch portion 9 being fitted into the fitting recess 8 to maintain a folded posture. The latch portion 9 is fitted into the fitting recess 8 when the cursor 3b is rotated to the second posture. Accordingly, the cursor 3b is stabilized at the second posture. When the cursor 3b is set in the second posture, each of the two leg portions 33a, 33a becomes in parallel to the guide rails 5b, 5b, so that the leg portions 33a, 33a face the guide rails 5b, 5b. The sliding movement of the end cursor 3 is guided by the guide rails 5b, 5b and the rail groove 5a.

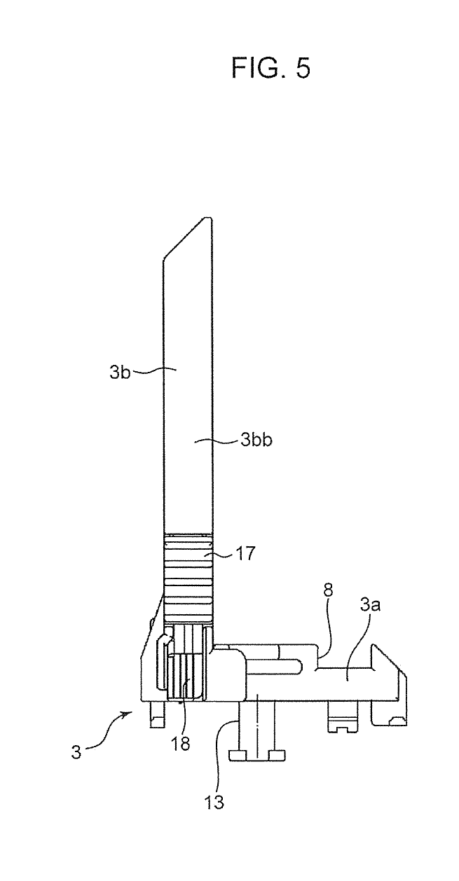

FIG. 5 is a side view showing the end cursor 3. The end cursor 3 is described with reference to FIGS. 2, 3 and 5. A grip portion 17, which protrudes outwardly in a width direction of the cursor 3b, and an engagement pawl 18, which is engaged with the rack cc (c.f. FIG. 3) of the sidewall 5c (c.f. FIG. 3) of the rail portion 5 are formed on a lateral surface 3bb of the cursor 3b. When an operator pinches the grip portion 17 by his/her fingers, the leg 33a of the cursor 3b is elastically deformed inwardly in the width direction, so that the engagement pawl 18 is disengaged from the rack 5cc. Accordingly, the end cursor 3 may be slid.

As shown in FIG. 3, the rotation restriction portion 6 includes two restriction pieces 11, 11, which are situated on lower ends of the two legs 33a, 33a of the cursor 3b, respectively, and two engagement recesses 6a, 6a, which are formed on the two guide rails 5b, 5b, respectively. Each of the two restriction pieces 11, 11 is shaped substantially in U shape opened upwardly. Each of the two restriction pieces 11, 11 protrudes from a respective one of the leg portions 33a, 33a of the cursor 3b in the first posture toward a downstream side in the sheet feeding direction. The two restriction pieces 11, 11 are fitted into and engaged with the engagement recesses 6a, 6a, respectively, when the cursor 3b is rotated to the second posture. Accordingly, the end cursor 3 is locked so as not to be moved toward the downstream side in the sheet feeding direction when the cursor 3b is in the second posture.

As shown in FIG. 3, the engagement recesses 6a, 6a are situated at respective positions of the guide rails 5b, 5b, each of which is adjacent to the upstream wall 2b. Each of the engagement recesses 6a, 6a is formed so as to be opened through a respective one of the guide rails 5b, 5b to a backside of the bottom plate 2a. Accordingly, a given position, at which each of the restriction pieces 11, 11 is engaged with a respective one of the engagement recesses 6a, 6a, is set at a position adjacent to the upstream wall 2b of the sheet feeding cassette 2.

As shown in FIG. 3, the lock portion 3c is situated on the upper surface of the base plate 3a. The lock portion 3c has a base end 3ca extending in a direction opposite to the sheet feeding direction, and a substantially triangle locking protrusion 3cb which protrudes from the base end 3ca outwardly in a width direction of the base plate 3a. The locking protrusion 3cb has a first inclined surface 3cba, which is brought obliquely in contact with a side edge 10 of an inner surface of each of the legs 33a, 33a of the cursor 3b set in the first posture, and a second inclined surface 3cbb, which connects the first inclined surface 3cba to the base end 3ca. Since the side edge 10 of the inner surface of each of the legs 33a, 33a is brought in contact with the first inclined surface 3cba, the cursor 3b is not rotated to the second posture even when a force acts to the cursor 3b in a direction causing a rotation of the cursor 3b from the first posture to the second posture. In short, the cursor 3b is locked in the first posture.

When a force causing elastic deformation of the base end 3ca is applied to the cursor 3b in the direction causing a rotation of the cursor 3b from the first posture to the second posture, the side edge 10 of the cursor 3b presses the first inclined surface 3cba. Accordingly, the base end 3ca is elastically deformed inwardly in the width direction of the base plate 3a. Meanwhile, the side edge 10 of the cursor 3b is slid on the first inclined surface 3cba in a direction toward an apex 16 of the locking protrusion 3cb. When the side edge 10 of the cursor 3b is moved beyond the apex 16, the rotation of the cursor 3b toward the second posture is facilitated by an elastic restoring force of the base end 3ca acting on the cursor 3b outwardly in the width direction of the base plate 3a.

The detector 4 shown in FIG. 2 includes a size detection lever 12 configured to be swung on a backside of the sheet feeding cassette 2, and a size detection sensor (not shown) which detects a position of the size detection lever 12 and outputs an electrical signal on the basis of the detected position. The size detection sensor is placed in an apparatus body (not shown) of the image forming apparatus in which the sheet storage device 1 is placed. The placement of the size detection sensor is not limited to the apparatus body. For example, the size detection sensor may be placed in the sheet feeding cassette 2.

As shown in FIG. 2, the size detection lever 12 is situated on the backside of the bottom plate 2a of the sheet feeding cassette 2. The size detection lever 12 includes a follower arm portion 12a, which is shaped in a rod and coupled to a protrusion shaft 13 (c.f. FIG. 5) protruding downwardly from a back surface side of the base plate 3a (c.f. FIG. 3) of the end cursor 3 (c.f. FIG. 3) and extending through the rail groove 5a (c.f. FIG. 3), and a sector portion 12b formed at a distal end of the follower arm portion 12a. A rotational pivot a is situated around a boundary between the follower arm portion 12a and the sector portion 12b. An elongated guide hole (not shown) extending in a length direction of the follower arm portion 12a is formed at a side of a proximal end of the follower arm portion 12a. The protrusion shaft 13 is fitted in the guide hole. Accordingly, the protrusion shaft 13 may be moved along the rail groove 5a and the guide hole during movement of the end cursor 3. The size detection lever 12 is rotated about the rotational pivot a during the movement of the protrusion shaft 13.

As shown in FIG. 2, convex portions 14, each of which protrudes radially outwardly, and concave portions 15, each of which is depressed radially inwardly, are alternately formed along an arc-shaped peripheral edge of the sector portion 12b. The size detection sensor outputs different electrical signals in response to a positional relationship between the convex portions 14 and the concave portions 15. Accordingly, a position of each of the convex portions 14 and the concave portions 15 with respect to the size detection sensor are set so that an electrical signal is output from the size detection sensor on the basis of the positions when the trailing edges of the sheets in the sheet feeding direction come into contact with the cursor 3b of the end cursor 3.

The sheet storage device 1 operates as described below. If sheets having a size other than the maximum size are stored in the sheet feeding cassette 2, an operator slides the end cursor 3 along the guide rails 5b, 5b at first to bring the cursor 3b into contact with trailing ends of the sheets in the sheet feeding direction. Accordingly, an electrical signal based on the position of the end cursor 3 is output from the size detection sensor, so that the size of the sheets is detected.

On the other hand, if sheets having the maximum size are stored in the sheet feeding cassette 2, an operator slides the end cursor 3 to the given position set at a position adjacent to the upstream wall 2b of the sheet feeding cassette 2, as shown in FIG. 1, and then rotates the cursor 3b from the first posture to the second posture, as shown in FIG. 4. Meanwhile, the restriction pieces 11, 11 are fitted into the engagement recesses 6a, 6a, respectively, so as to allow the rotation of the cursor 3b from the first posture to the second posture. The operator then stores the sheets having the maximum size in the sheet feeding cassette 2 so that the trailing edges of the sheets in the sheet feeding direction are brought into contact with the upstream wall 2b of the sheet feeding cassette 2. Meanwhile, an electrical signal based on the position of the end cursor 3 is output from the size detection sensor, so that the maximum size of the sheets is detected. Since the upstream wall 2b of the sheet feeding cassette 2 is used as a reference for setting the position of the trailing edges of the sheets having the maximum size, as described above, it may be possible to realize a design for increasing a detectable sheet size without causing an increase in size of the sheet storage device 1.

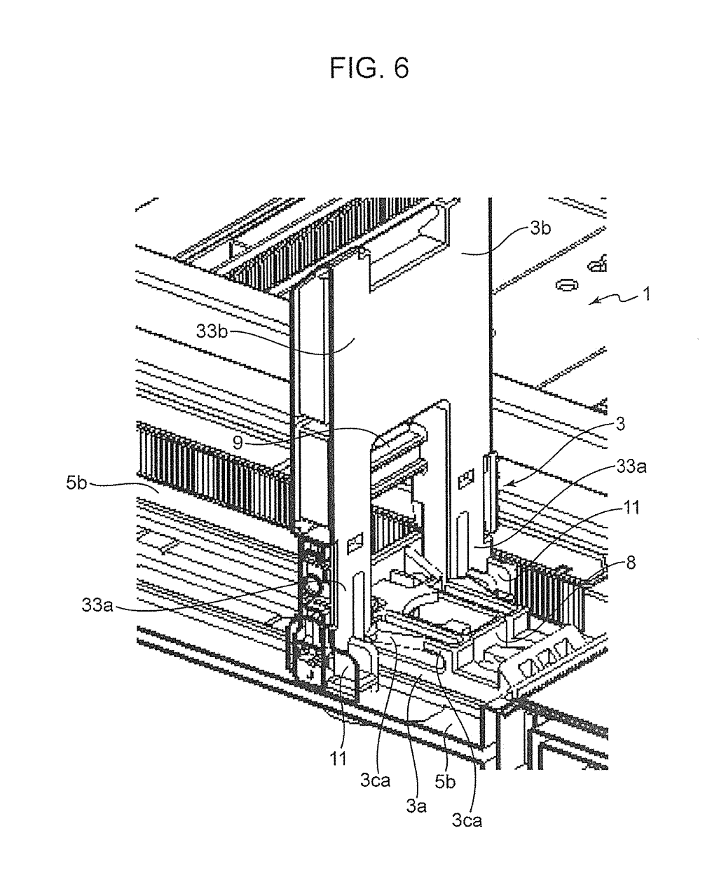

FIG. 6 is a perspective view showing the end cursor 3 located at a position distant from the given position. The end cursor 3 is described with reference to FIGS. 3, 4 and 6. The restriction pieces 11, 11 located at a position distant from the given position are brought into contact with the guide rails 5b, 5b, respectively, even when an operator rotates the cursor 3b of the end cursor 3 from the first posture toward the second posture. Accordingly, the operator may not fold the end cursor 3. Therefore, it is prevented for the operator to erroneously put sheets on the end cursor 3 located at a position distant from the given position. Therefore, the sheet storage device 1 is less likely to cause a false detection, in which a sheet size is detected on the basis of a position of the end cursor 3 distant from the given position.

As shown in FIG. 4, when the cursor 3b is in the second posture at the given position, the restriction pieces 11, 11 are engaged with the engagement recesses 6a, 6a (c.f. FIG. 3), respectively. Accordingly, even when a force acts on the end cursor 3 in the sheet feeding direction, the end cursor 3 is less likely to be displaced. Therefore, the sheet storage device 1 is less likely to cause a false detection of sheet size.

With regard to the aforementioned embodiment, the given position in the sheet feeding direction is set at one position adjacent to the upstream wall 2b of the sheet feeding cassette 2. Alternatively, a plurality of given positions may be set in the sheet feeding direction.

Although the present disclosure has been fully described by way of example with reference to the accompanying drawings, it is to be understood that various changes and modifications will be apparent to those skilled in the art. Therefore, unless otherwise such changes and modifications depart from the scope of the present disclosure hereinafter defined, they should be construed as being included therein.

1. A sheet storage device comprising:
a sheet feeding cassette configured to store a sheet;
an end cursor supported so as to rotate between a first posture, at which the end cursor protrudes upwardly from a bottom plate of the sheet feeding cassette, and a second posture, at which the end cursor is situated in parallel to the bottom plate, the end cursor in the first posture being brought into contact with trailing edge of the sheet in a sheet feeding direction;
a guide rail extending on the bottom plate along the sheet feeding direction to guide a sliding movement of the end cursor;
a detector configured to detect the size of the sheet based on a position of the end cursor in the sheet feeding direction; and
a rotation restriction portion restricting a rotation of the end cursor from the first posture to the second posture, and including a restriction piece situated on the end cursor so as to be brought into contact with the guide rail and restrict the rotation of the end cursor from the first posture to the second posture; and an engagement recess formed at a given position of the guide rail so that the restriction piece is fitted in the engagement recess, wherein
the end cursor is allowed to rotate from the first posture to the second posture when the restriction piece is fitted in the engagement recess at the given position of the guide rail.

2. The sheet storage device according to claim 1, wherein
the restriction piece of the rotation restriction portion is engaged with the engagement recess when the end cursor is in the second posture.

3. The sheet storage device according to claim 1, wherein
the sheet feeding cassette includes an upstream wall standing at an upstream of the end cursor in the sheet feeding direction,
the guide rail has an upstream end located at a position adjacent to the upstream wall, and
the given position of the guide rail is in correspondence to a position at which the end cursor is placed at the upstream end of the guide rail.

4. The sheet storage device according to claim 3, wherein
the end cursor is in the second posture and the upstream wall restricts the trailing edge of the sheet when the sheet having a maximum size acceptable for storage is accommodated in the sheet feeding cassette.

5. The sheet storage device according to claim 1, wherein
the restriction piece is brought into contact with the guide rail while the end cursor located at a position distant from the given position is rotated from the first posture toward the second posture.

6. The sheet storage device according to claim 1, wherein
the end cursor includes a base plate, which is shaped substantially in a flat plate and slidable along the guide rail, and a cursor, which is attached to the base plate so as to be rotatable between the first and second postures and brought in contact with the trailing edge of the sheet, and
the restriction piece is located on the cursor.

7. The sheet storage device according to claim 6, wherein
the end cursor includes a lock portion provided on an upper surface of the base plate, the lock portion being brought in contact with the cursor to lock the cursor in the first posture.

8. An image forming apparatus comprising the sheet storage device according to claim 1.
